(19) United States
(12) Patent Application Publication
(10) Pub. No.: US 2022/0095844 A1
(43) Pub. Date: Mar. 31, 2022

(54) Container having universally usable, hidden handle fastening for use with domestic appliances

(71) Applicant: DE'LONGHI BRAUN HOUSEHOLD GMBH, Neu-Isenburg (DE)

(72) Inventors: Andreas Persich, Kuelsheim-Steinbach (DE); Norbert Kreutz, Wehrheim (DE); Markus Ungerer, Muehltal (DE); Sven Wuttig, Griesheim (DE); Hannes Essmann, Frankfurt (DE)

(21) Appl. No.: 17/310,451

(22) PCT Filed: Feb. 7, 2020
(86) PCT No.: PCT/EP2020/053126

§ 371 Date: Aug. 4, 2021

(30) Foreign Application Priority Data
Feb. 8, 2019 (DE) 20 2019 100 726.5

(51) Int. Cl. A47J 43/07; A47J 45/06

(52) U.S. Cl. CPC A47J 43/0727; A47J 43/0777; A47J 43/0722; A47J 45/067

(57) ABSTRACT

A container for domestic appliances, wherein the container includes a handle, a circumferential outer side wall and at least one opening on an upper side of the container. The container includes at least one fastening element integral with the side wall, characterized in that the fastening element is a hook which extends in a first direction outwards from the side wall and also extends in a second direction essentially parallel to the side wall. The handle forms a form-fitting connection with the container via the at least one fastening element.

### TECHNICAL FIELD

The present invention relates to a container for domestic appliances. In the present context, domestic appliances are in particular understood to be blenders, mixers, hand blenders, food processors, juicers, coffee machines, kettles and ironing stations.

### PRIOR ART

Many domestic appliances (e.g. blenders) comprise containers that are typically intended for storing or processing food. Some of these domestic appliances and the corresponding containers come in a variety of configurations, with some configurations comprising a glass container, while others comprise a plastic container of similar size and design. Plastic handles are also frequently provided on the glass containers used since a hollow space is required in the handle for accommodating safety or locking mechanisms. However, based on the known options for fastening plastic handles to glass jugs, it is usually not possible to achieve a uniform design for plastic handles on glass jugs and handles of all-plastic jugs.

The known options for fastening plastic handle geometries to glass jugs are often realized by covering an internal glass handle. The glass handle is used for stability and for anchoring the plastic parts to the glass jug. Additional integration of safety elements for determining the position of the lid then leads to a very large geometry of the handle, which is disadvantageous from a handling and design point of view. Fastening of the plastic handles by means of metallic rings (see, for example, EP 1 396 220 A1), which is known as well, is also disadvantageous with regard to design.

Glued connections are furthermore known, which allow great freedom of design, but have other disadvantages. For example, the selection of plastics is limited in this case since not all allow for good adhesion. Furthermore, the glued connection can dissolve over a long period of time or if processed incorrectly (e.g. contamination).

### DESCRIPTION OF THE INVENTION

One object of the present invention is to provide a possibility for fastening a plastic handle to a container in a compact manner, in particular a possibility for fastening a plastic handle to a glass container in a compact manner. Owing to the compact structure, the geometry of the handle can be designed with maximum freedom, and it is thus possible to design an all-plastic container and a glass container having a plastic handle to be optically the same. A further object of the present invention is to provide fastening points that are not visible from the outside, unlike metal rings, for example. Furthermore, the fastening should ensure reliable connection of the handle to the container over a long period of time.

According to the invention, the object is solved by means of a container for domestic appliances having the features of claim 1 as well as a domestic appliance for food processing having the features of claim 7. Preferred features of embodiments can be found in the subclaims.

The present invention provides a container for domestic appliances. The container comprises a handle, a circumferential outer side wall and at least one opening on the upper side. The container furthermore comprises at least one fastening element that is integral with the side wall. The fastening element is a hook that extends in a first direction outwards from the side wall and extends in a second direction essentially parallel to the side wall in the direction of the opening. The fastening element thus comprises a clearance between the side wall and the section extending in the second direction essentially parallel to the side wall, the clearance extending in the direction of the opening from the section extending in the first direction. The handle thereby forms a form-fitting connection with the container via the at least one fastening element.

The hook-shaped fastening element provides a compact fastening possibility that allows a handle to be freely designed and securely fastened with the same configuration to containers made of different materials.

In a preferred embodiment, the container is a glass container, preferably a glass jug.

Fastening additional elements, e.g. handles or safety elements, to glass jugs requires more effort since they are brittle and non-elastic. Due to these characteristics, it is not possible to use conventional fastening methods such as screw connections or snap-fit connections. In order to use said methods, auxiliary means such as metal rings or plastic skirts have to be used. However, solutions using these auxiliary means can have a negative impact on the visual impression of a product. This is even more true for glass jugs since they are often used in higher-quality products. The technical objective in the case of these products is to attach additional elements on as small a fastening surface as possible so as to not disrupt the visual impression.

The handle is more preferably made of plastic. A handle made of plastic exhibits many desirable design properties. For example, it is both light and capable of comprising more complex internal geometries, with which it can also accommodate further desired elements. The handle can furthermore be formed into more complex and visually appealing shapes in a cost-effective manner.

The handle more preferably comprises an inner handle shell, an outer handle shell and at least one holding element. The inner handle shell and the holding element are preferably arranged such that they form the form-fitting connection with the fastening element.

The holding element comprises a protrusion that engages with the hook, as a result of which the holding element and the inner handle shell are fixed in the first direction. The holding element is at the same time connected in the second direction to the inner handle shell which lies opposite the hook, as a result of which the holding element and the inner handle shell are also fixed in the second direction. In one embodiment, the at least one holding element is connected to the inner handle shell by means of at least one screw connection.

By configuring the handle as two parts, i.e. with an inner handle shell and an outer handle shell, the inner handle shell with the holding element can be securely fastened to the container, and the connection, including the fastening element and the holding element, can subsequently be covered by the outer handle shell. This configuration allows the handle to be configured in a compact manner and the shape thereof remains highly adaptable. This embodiment also has advantages with regard to a design of different model variants for the container. For example, in a plastic container variant intended for the entry-level market, the inner handle shell can be directly manufactured as part of the basic body of the container, e.g. by injection molding, whereas a visually identical handle fastened via a fastening element, as described above, can be used for a glass container for a product of higher quality. It would also be possible to use the integrally formed fastening element according to the invention in a plastic container. In each of these cases, both the visual difference between the variants and the variance of the handle parts is reduced, more common parts can be used, and it is thus possible to reduce costs.

In a preferred further development, the container comprises a second fastening element, the handle comprises a second holding element, and the inner handle shell and the second holding element are preferably arranged such that they form a second form-fitting connection with the second fastening element.

A handle can be fastened at two points of the container via a second fastening element, which results in a more secure fastening of the handle since both ends of the handle can be fixed to the container. If the handle is fastened to only one fastening element, moments may be initiated by the lever arm generated by the handle, depending on the configuration of the handle. In that case, said moments must be absorbed by the handle and the fastening element. Moment-free force application is mechanically better and puts less stress on both the handle and the fastening element. In addition, two fastening elements are better suited to absorbing higher forces than a single fastening element. When using two fastening elements, it would also be possible to reduce the dimensions of both fastening elements whilst retaining the same force absorption, and to offer to the end customer a more appealing product having a handle with smaller dimensions.

In a further embodiment, the second fastening element, the second holding element and the second form-fitting connection are configured in conformity with the first fastening element, the first holding element and the first form-fitting connection. In this context, “configured in conformity with the first fastening element, the first holding element and the first form-fitting connection” is to be understood to mean that the second fastening element is also a hook that extends in a first direction outwards from the side wall and extends in a second direction essentially parallel to the side wall in the direction of the upper opening. The second holding element corresponds to the first holding element and comprises a protrusion that engages with the hook of the second fastening element, as a result of which the second holding element and the inner handle shell are fixed in the first direction. At the same time, the second holding element is connected, in the second direction, to the inner handle shell which lies opposite the hook of the second fastening element, as a result of which the second holding element and the inner handle shell are also fixed in the second direction.

By using the same configuration of fastening and holding elements, the variety of required components can be reduced and the assembly steps are simplified by repetition.

The container more preferably comprises a second opening, the second opening being arranged on the lower side of the container. The container can furthermore comprise a closing unit that is arranged to close the second opening. The handle can be fastened to the container via the fastening element and the closing unit.

In this embodiment, the container comprises an upper opening and a lower opening. The lower opening can be closed by means of the closing unit. The closing unit can comprise a work tool, for example a rotatable blade that is disposed inside the container owing to the closing unit.

A further possibility for fastening a handle to the container is also made possible by a closing unit. For example, when using a glass container, the closing unit may be made of plastic and enable a cost-effective connection to a lower end of a handle, such as by means of a snap connection. However, the closing unit can also comprise a fastening element according to the invention.

The present invention furthermore provides a domestic appliance for food processing, which comprises a container according to one of the embodiments described above. The domestic appliance furthermore comprises a housing. The housing comprises an electrically operated effector, a safety device, a base and a lid. The safety device is arranged in the circuit for current feed of the effector in such a manner that said device only closes the circuit if the safety device is actuated. The base is further configured to receive the container, and the lid is configured to close the first opening of the container.

The handle of the container essentially extends along the entire height of said container and comprises a hollow space. A safety element is arranged in the hollow space in such a manner that it actuates the safety device if the container is closed with the lid.

With such a domestic appliance according to the invention, it is possible to ensure that the container is securely closed by the lid before the effector can be actuated. The safety element is best configured as a mechanical safety element which ensures, even in the event of contamination or improper handling, that the circuit of the effector is not closed if the container is not properly closed. It would also be conceivable to configure the safety element as an electric conductor that detects the safe position of the lid by means of an electric switch, an inductive or optical signal, or an RFID system, and thereupon closes the circuit of the effector. Various solutions regarding safety devices for closing a circuit are known to the person skilled in the art, which may all be applied here.

The securely closed lid can prevent potential household accidents, such as actuating the blade unit of a blender or heating a kettle while the lid is not closed. In this case, the user of the domestic appliance may come to harm if said user reaches into the container during operation.

In a preferred further development, the container of the domestic appliance is a container comprising a second opening, the opening being arranged on the lower side of the container. The container furthermore comprises a closing unit that is arranged to close the second opening. In said further development, the handle is fastened to the container via the fastening element and the closing unit.

The effector is an electric motor, the drive shaft of which traverses the base outwards from the housing.

A work tool is arranged in the closing means, which is connected to the drive shaft of the motor if the container is arranged on the base. The work tool is preferably a rotatable blade unit.

In this case, the domestic appliance is a mixer or a blender, for which it is very important that no user of the domestic appliance comes into contact with the blade unit during operation since this may lead to severe injuries. Such a case is not unlikely if the lid is opened, for example during refilling or pressing of the content of the container.

In a further development, the lid is configured to lock with the first opening of the container. The lid is more preferably locked with the first opening via a bayonet catch.

Locking of the lid provides additional safety and easier handling. The locking ensures that the lid maintains its position on the opening of the container during operation, without the user having to manually hold the lid in position. A bayonet catch furthermore has the property that the lid is rotated about the height axis thereof after placing the lid on the container. The effective movement acting on the safety element can thereby be varied. It can thus be a vertical movement acting in the direction of the height axis of the container or lid, and, likewise, the effective movement can also be the rotation of the lid.

Further preferred features and advantages are revealed in the following description of the figures and the entirety of the claims.

### BRIEF DESCRIPTION OF THE FIGURES

The invention is described in more detail in the following section by way of embodiment examples with reference to the enclosed figures.

FIG. 1a shows a container for use in a domestic appliance according to an embodiment example of the present invention.

FIG. 1b shows the container of FIG. 1a in an exploded view.

FIG. 2 shows the integrally formed fastening element of the container from FIG. 1a and FIG. 1b in a detailed view.

FIG. 3 shows the holding element from FIG. 1a and FIG. 1b in a perspective view.

FIG. 4 shows the fastening of the inner handle shell via the fastening element and the holding element from FIG. 1a and FIG. 1b in a sectional view.

In the figures, identical reference numbers designate the same components or components that are similar in function, unless otherwise indicated.

### MANNERS OF IMPLEMENTING THE INVENTION

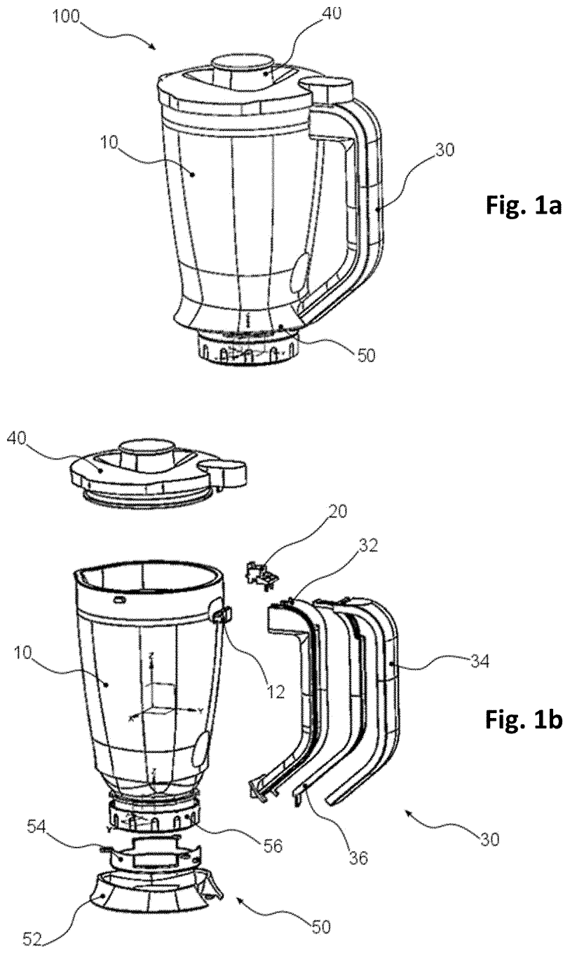

An embodiment of a container 100 for domestic appliances is shown in FIG. 1a and FIG. 1b. In this embodiment, the container is a glass container 10 for a blender. The glass container 10 comprises an upper opening that can be closed by a lid 40, and a lower opening that is provided with a thread. Closing means 50 with a work tool, for example a rotating blade in the case of a blender, can be screwed on the thread. The closing means 50 comprises a plastic skirt 52, a fastening ring 54 and a threaded ring 56.

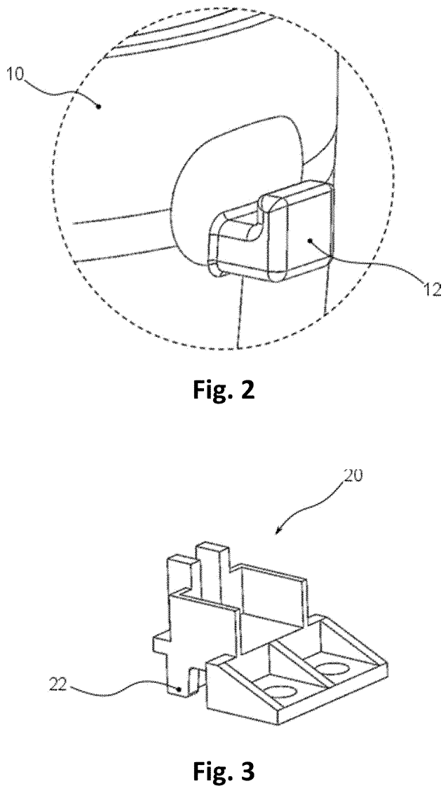

The container comprises a fastening element 12, shown in FIG. 2, which is a integrally formed glass element in this embodiment. The glass element 12 is shaped as a hook and extends in a first direction radially outwards from the external surface of the container 10 and then in a second direction towards the upper opening of the glass container. The handle 30 is fastened to said glass element 12. In this embodiment, the handle 30 consists of four components, i.e. an inner handle shell 32, a holding element 20, shown in FIG. 3, an outer handle shell 34 and a safety element 36.

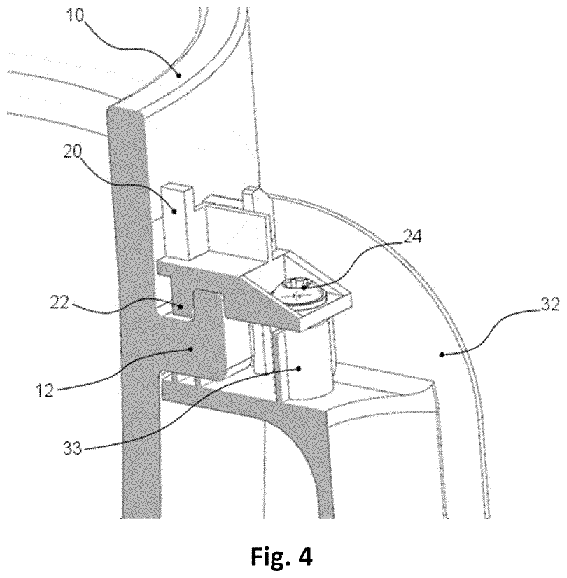

FIG. 4 shows the arrangement of the inner handle shell 32 and the holding element 20 around the integrally formed fastening element 12 in a sectional view. The inner handle shell 32 supports itself against the fastening element 12 from below by means of a shoulder. Starting from the inner handle shell 32, the holding element 20 is arranged opposite the fastening element 12. The holding element 20 engages from above, by means of a protrusion 22, with the hook shape of the fastening element 12 and is screwed to the inner handle shell 32 by screws 24 being screwed through the holding element 20 into the screw bosses 33 of the inner handle shell. The safety element 36 is arranged externally around the inner handle shell 32. The outer handle shell 34 is finally placed onto the inner handle shell 32 and held in position by means of snap fits, for example. The safety element 36 is arranged between the inner handle shell 32 and the outer handle shell 34 such that the safety element 36 is pressed in the direction of the lower opening by the lid 40 if the lid is arranged on the glass container 10.

In this embodiment, only the upper end of the handle 30 is fastened to the container by the fastening element 12. The lower end of the handle 30 is fastened by means of the closing means 50 screwed on the lower opening of the glass container 10, for example via a snap fit on the plastic skirt 52 or via a screw connection to the fastening ring 54. However, it would also be conceivable to arrange second fastening means, in conformity with the first fastening means 12, at another point of the glass container 10, and thus to fix the handle 30 via a further holding element 20.

In this embodiment, the tolerances of the holding element 20 and the inner handle shell 32 are selected so as to compensate dimensional deviations owing to manufacturing tolerances of the integrally formed glass element 12. A secure connection between the holding element 20 and the handle shell 32 is thus ensured. The screw connection of the holding element 20 to the screw bosses 33 of the inner handle shell 32 provides further tolerance compensation.

A safety element 36 is arranged within the handle shell 30. Said safety element 36 is configured in such a way that the safety element 36 within the handle shell 30 is shifted in the direction of the lower opening if the container 10 is closed by means of the lid 40, and exits the handle shell 30 at the lower end. The purpose of the safety element 36 is that said safety element 36 enters the housing if the container 10 is fastened on the housing of the blender and closes the circuit in order to actuate the motor via a switching element arranged therein. This thus ensures that the work tools within the container 10 only work if the container 10 is properly closed. This is specifically necessary if the work tools comprise sharp blades, such as the rotating blades of a mixer.

### LIST OF REFERENCE NUMBERS

10 Glass container
12 Fastening element
20 Holding element
22 Protrusion
24 Screw
30 Handle
32 Inner handle shell
33 Screw boss
34 Outer handle shell
36 Safety element
40 Lid
50 Closing means
52 Plastic skirt
54 Fastening ring
56 Threaded ring
100 Container

A full listing of the claims follows:

1. A container for domestic appliances comprising a handle, a circumferential outer side wall, and at least one opening on an upper side of the container,
wherein the container further comprises at least one fastening element integral with the outer side wall,
wherein the fastening element comprises a hook which extends in a first direction outward from the outer side wall and also extends in a second direction essentially parallel to the outer side wall, and
wherein the handle forms a form-fitting connection with the container by the at least one fastening element.

2. The container according to claim 1, wherein the container is a glass container.

3. The container according to claim 1, wherein the handle is made of plastic.

4. The container according to claim 1, wherein the handle comprises an inner handle shell, an outer handle shell and at least one holding element,
wherein the inner handle shell and the holding element form a form-fitting connection with the at least one fastening element,
wherein the holding element comprises a protrusion that engages with the fastening element, wherein the holding element and the inner handle shell are fixed in a first direction,
wherein the holding element is connected in a second direction to the inner handle shell which lies opposite the fastening element whereby the holding element and the inner handle shell are fixed in a second direction, and
wherein the at least one holding element is connected to the inner handle shell by at least one screw connection.

5. The A container according to claim 4, wherein the container further comprises a second fastening element,
wherein the handle further comprises a second holding element,
wherein the inner handle shell and the second holding element form a second form-fitting connection with the second fastening element, and
wherein the second fastening element, the second holding element and the second form-fitting connection are configured with the first fastening element, the first holding element and the first form-fitting connection.

6. The container according to claim 1, wherein further comprising a second opening,
wherein the second opening is on a lower side of the container,
wherein the container further comprises a closing unit that closes the second opening, and
wherein the handle is fastened to the container by the fastening element and the closing unit.

7. A domestic appliance for food processing, comprising the container according to claim 1,
wherein the domestic appliance comprises a housing, wherein said housing comprises:
an electrically operated effector,
a safety device arranged in a circuit for current feed of the effector, wherein the safety device only closes the circuit if the safety device is actuated,
a base to receive the container,
a lid that closes the first opening of the container,
wherein the handle extends along an entire height of the container and comprises a hollow space,
wherein a safety element is arranged in the hollow space, and
wherein the safety element actuates the safety device if the container is closed with the lid.

8. The domestic appliance according to claim 7,
wherein the effector is an electric motor, wherein a drive shaft of the motor traverses the base,
wherein the container further comprises a work tool arranged in the closing element and connected to the drive shaft of the motor when the container is arranged on the base, and
wherein the work tool comprises a rotatable blade unit.

9. The domestic appliance according to claim 7, wherein the lid locks the first opening of the container, and wherein the lid is locked with the first opening by a bayonet catch.

10. The container of claim 1, wherein the container is a glass jug.
